(19) United States
(12) Patent Application Publication
(10) Pub. No.: US 2022/0383341 A1
(43) Pub. Date: Dec. 1, 2022

(54) ENTITY HEALTH EVALUATION MICROSERVICE FOR A PRODUCT

(71) Applicant: Microsoft Technology Licensing, LLC, Redmond, WA (US)

(72) Inventors: Tianyi Chen, Sammamish, WA (US); Muskan Kukreja, Redmond, WA (US); Rodrigo Ignacio Vergara Escobar, Redmond, WA (US); Ehsan Vahedi, Newcastle, WA (US)

(21) Appl. No.: 17/333,448

(22) Filed: May 28, 2021

(51) Int. Cl. G06Q 30/02; G06N 20/00

(52) U.S. Cl. CPC G06Q 30/0201; G06N 20/00

(57) ABSTRACT

Systems and methods for evaluation of entity health for a product are described. In some embodiments, a computing system can receive data defining values of a group of diagnostic signals pertaining to a domain of a product of an entity. The computing system can then generate attributes indicative of entity health condition in the domain by applying a machine-learning model to the data. The attributes can include a health reward parameter and a signal strength parameter. The computing system also can encode the health reward parameter in a particular marking according to a marking schema. The computing system can further cause presentation of the particular marking and/or the signal strength parameter.

### BACKGROUND

Business customers can be highly heterogenous. Thus, a same software solution can behave dramatically different among those customers. As such, evaluating operational pressure on a computing architecture of business customer that consumes the software solution can be a tool for understanding product attrition and overall quality of customer experience. A measure of that operational pressure can reveal a consumer product health or lack thereof.

Given the large quantities of business customer feedback (requests for bug fixes, functionality improvement, etc.) for software-as-a-service (SaaS) providers, and given the limited time and resources to address operational issues, evaluating consumer product health can be quite challenging. As a result, entities at significant risk of product attrition may be underserviced.

Adding to that complexity, business customers use SaaS products in various media (platforms, apps, versions, etc.) and in various patterns. Some entities may heavily rely on one type of software application to analyze quantitative data, while other entities may heavily use another type of software application for presentations and yet another type of software presentation for homework, for example. The high variance and the high diversity of customer behaviors make it difficult, if not plain unfeasible, for SaaS providers to evaluate consumer health comprehensibly.

### BRIEF SUMMARY

Systems and methods for evaluation of entity health for a product are described. The described system and methods provide a systematic framework that can systematically address the issue of evaluating entity health. Consumer product health, or “entity health” of a product refers to the overall consumer product experience and return on investment (ROI) on the consumer's investment in the product.

Embodiments of the disclosure can use machine-learning models that can generate multiple attributes, each providing an assessment, qualitative or quantitative, of entity health. In some embodiments, the disclosure provides a computing system that includes multiple assessor subsystems. Each of those subsystems can serve as a microservice that can flexibly consume diagnostic signals, can evaluate entity health in a particular domain of the product using the diagnostic signals, and can generate output data that characterizes entity health in multiple facets. The output data can define a marking, such as a color, that can encode entity health in terms of a health index, such as a health reward parameter. In some embodiments, the assessor subsystems can be functionally coupled to, or can include, an aggregation subsystem to determine an overall characterization of entity health for an entity.

It is noted that the above-described subject matter can be implemented as a computing system, a computer-implemented method, computer-controlled apparatus, or as an article of manufacture, such as a computer-readable storage medium. These and various other features will be apparent from a reading of the following Detailed Description and a review of the annexed drawings.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Further, the claimed subject matter is not limited to implementations that solve any or all disadvantages noted in any part of this disclosure.

### BRIEF DESCRIPTION OF THE DRAWINGS

FIG. 1 illustrates an example operating environment for evaluation of entity health for a product, in accordance with one or more aspects of this disclosure.

FIG. 2 illustrates a tree representing various product domains for an entity that consume a SaaS solution, in accordance with one or more embodiments of the disclosure.

FIG. 3 illustrates an example of how marking-coding results can be mapped onto a two-dimensional feature space, in accordance with one or more embodiments of this disclosure.

FIG. 4 summarizes an example of correlations among output signals obtained by evaluating entity health for a product, in accordance with one or more aspects of this disclosure.

FIG. 5 illustrates an example operating environment that can generate the overall health score and corresponding signal strength, in accordance with one or more aspects of this disclosure.

FIG. 6 presents an example of aggregation of health data over several domains of a product for a defined entity, in accordance with one or more aspects of this disclosure.

FIG. 7 presents an example of a subsequent aggregation of health data across prior health data for several domains of a product for a defined entity, in accordance with one or more aspects of this disclosure.

FIG. 8 illustrates an example of a discretization of health scores into a group of defined markings, in accordance with one or more embodiments of this disclosure.

FIG. 9 illustrates an example of a user interface that can present a defined marking characterizing entity health, in accordance with one or more embodiments of this disclosure.

FIG. 10 illustrates an example of a method for evaluating entity health pertaining to a product, in accordance with one or more embodiments of this disclosure.

FIG. 11 illustrates an example of a method for generating a health score that summarizes entity health pertaining to a product across domains of the product, in accordance with one or more embodiments of this disclosure.

FIG. 12 illustrates an example computing environment that may carry out the described process, in accordance with one or more embodiments of this disclosure.

### DETAILED DESCRIPTION

Systems and methods for evaluation of entity health for a product are described. The described system and methods provide a systematic framework that can systematically address the issue of evaluating entity health. Embodiments of the disclosure can use machine-learning models that can generate multiple attributes, each providing an assessment, qualitative or quantitative, of entity health. In some embodiments, the disclosure provides a computing system that include multiple assessor subsystems. Each of those subsystems can serve as microservice that can flexibly consume diagnostic signals, can evaluate entity health in a particular domain of the product using the diagnostic signals, and can generate output data that characterizes entity health in multiple facets. The output data can define a marking, such as a color, that can encode entity health in terms of a health index, such as a health reward parameter. In some embodiments, the assessor subsystems can be functionally coupled to, or can include, an aggregation subsystem to determine an overall characterization of entity health for an entity.

This disclosure recognizes and addresses, among other technical challenges, the complexity of evaluating operational pressure on an entity that consumes a computer-implemented product, such as a B2B SaaS product.

Implementation of the technologies disclosed herein can provide several improvements over existing technologies. For example, the additivity, robustness, generalizability, and customizability of the embodiments of the disclosure render the technologies described herein powerful and viable for application on various scenarios. Feedforward aggregation on microservice outputs can provide actionable information that can permit more efficiently use of computing resources and/or human-resource time compared to existing technologies for customer health assessment. By characterizing entity health in terms of a defined marking and/or a parameter providing a confidence level on the defined marking, embodiments of the disclosure can focus the usage of computing resources on entities that display significant product attrition. As a result, the computing platform that provide the product as a service can operate significantly more efficiently than existing computing systems for evaluation of customer health.

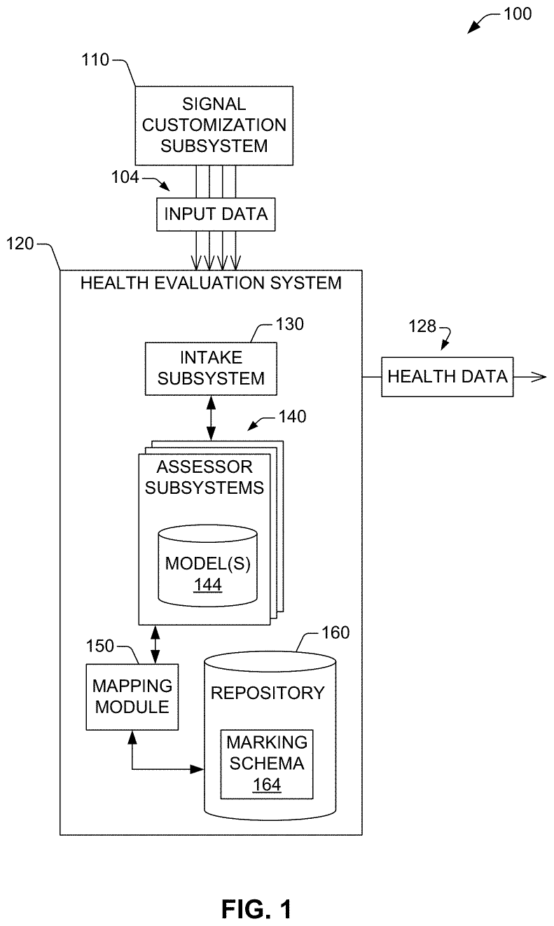

With reference to the drawings, FIG. 1 illustrates an example operating environment for evaluation of entity health for a product, in accordance with one or more aspects of this disclosure. An operating environment 100 can include a signal customization subsystem 110 that can generate input data 104 for a domain of the product. Here, a domain of the product (or product domain) refers to a combination of specific aspects of functionality of, or interaction with, a component of the product and other components that can administer that functionality. An example of a domain can be reliability of a software application for a defined platform (such as a particular O/S) available to the product.

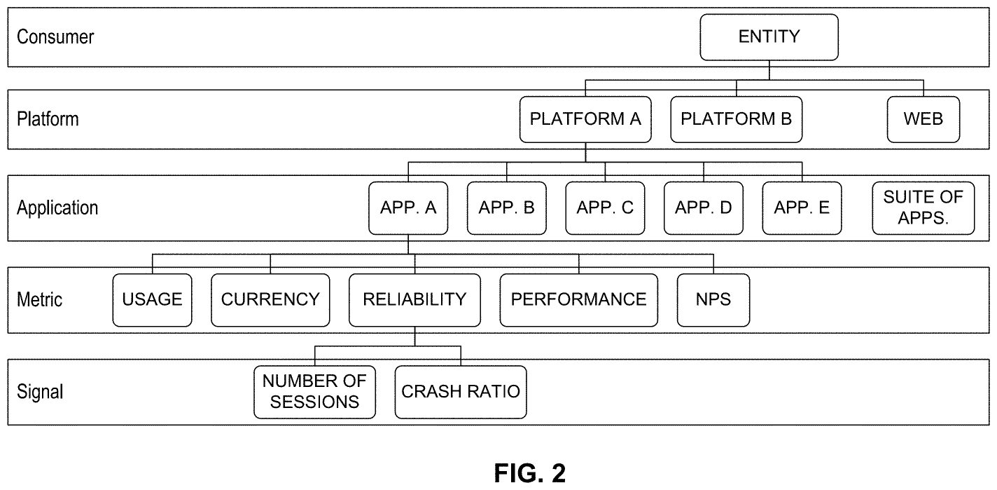

The input data defines values of a group of diagnostic signals that is specific to that domain. In some embodiments, the signal customization subsystem 110 can monitor streams of data that become available during interaction between the entity and the product. The signal customization subsystem 110 can select a subset of the streams of data to generate a diagnostic signal. As is illustrated in FIG. 2, in a case where the domain of the product is Platform A/Application B/Reliability, the signal customization subsystem 110 can use data indicative of initiation of a session of a software application that is part of the product in order to generate a number of sessions during a defined period of time. The number of sessions represents a diagnostic signal.

The signal customization subsystem 110 also can operate on one or more data streams in order to determine failure rates in conducted sessions. For instance, the ratio between number of sessions that have crashed and number of sessions conducted without a crash during a defined period represents another diagnostic signal. Such a ratio can be referred to as “crash ratio.” Besides determining crash ratios, in some cases, the signal customization subsystem 110 can determine a number of anomaly pivots detected for an add-in (new or extant) or crashes related to decisions made according to customer health. For purposes of illustrations, detecting an anomaly pivot can refer to detecting distinct types of anomaly crashes in a Platform/Application/Version domain that can cause performance of a corrective action (e.g., software bug fix) and/or root-cause analysis. Number of anomaly pivots represents yet another diagnostic signal. For another domain of the product, such as Platform B/Application D/Performance, the group of diagnostic signals can include boot launch time and/or file open time.

The operating environment 100 also includes a health evaluation system 120. The health evaluation system 120 can include an intake subsystem 130 that can receive the input data 104 defining values for different groups of diagnostic signals specific to respective domains of the product. The intake subsystem 130 can separate the input data 104 according to product domain in preparation for health evaluation for at least one of the respective domains of the product. That is, the intake subsystem 130 can identify first input data from the input data 104 corresponding to diagnostic signal(s) for a first domain of product, and also can identify second input data from the input data 104 corresponding to diagnostic signal(s) for a second domain of product. In one example, the first domain of product can be Platform/Application/Metric I and the second domain of product can be Platform/Application/Metric II. Here, Metric I and Metric II are different and each can be selected from the Metric tier of the tree 200. As is illustrated in FIG. 2, the Metric tier includes usage, currency, reliability, performance, and NPS.

The health evaluation system 120 can include multiple assessor subsystems 140. Each one of the multiple assessor subsystems 140 can constitute a microservice. The multiple assessor subsystems 140 can evaluate entity health for respective domains of a product of an entity. To that end, each one of the multiple assessor subsystems 140 can retain one or more respective classification model(s) 144 configured to operate on one or more diagnostic signal pertaining to a particular product domain. Thus, a first classification model of the classification model(s) 144 retained in a first assessor subsystem of the assessor subsystem 140 can be different from a second classification model of the classification model(s) 144 retained in a second assessor subsystem of the assessor subsystems 140. Further, for a particular domain, an assessor subsystem of the assessor subsystems 140 can quantify entity health by applying the classification model(s) 144 to input data 104 defining values of a group of diagnostic signals for the particular domain.

Accordingly, quantifying the entity health can include generating attributes indicative of entity health condition. The attributes can include at least one classification attribute. A first classification attribute of the at least one classification attributes can include a label that designates an entity as pertaining to a particular category of health. The label can be embodied in natural-language term(s) or another type of code (such as a string of alphanumeric codes). Regardless of its format, the label is one of multiple labels defined during training of the classification model(s) 144. An example of the multiple labels can include “High Product Attrition,” “Moderate Product Attrition,” “Low Product Attrition,” “Negligible Product Attrition,” “Undefined” (e.g., noise). A second classification attribute can include a signal strength parameter defining a confidence level on the attribution of the values of the group of diagnostic signals to the label.

As part of quantifying entity health in a product domain, by applying the classification model(s) 144 to input data defining values of a group of diagnostic signals for a particular domain of a product, an assessor subsystem of the assessor subsystems 140 can determine classification attributes including a classification attribute that defines a health rating of a group of health ratings. In some embodiments, health ratings can be numeric and the group of health ratings can include as many health ratings as categories of health. Such health ratings can be mapped in one-to-one fashion to the categories of health. In addition, or in other embodiments, the classification attributes also can include a classification attribute that defines a health reward parameter.

Accordingly, by applying the classification model to input data, the assessor subsystem can encode a health reward parameter in a particular marking according to a marking schema 164. The marking encoding of the health reward parameter can represent a level of product attrition. In other words, a marking can convey a level of strain placed on operations of the entity by consuming the product. Accordingly, when presented at a user interface or an electronic document, for example, not only can the particular marking readily convey an entity health condition of the entity, but the particular marking can control corrective actions to improve product experience. An example of a corrective action can include generating and/or sending a message to a computing device (such as a user device) administered by a computing system of the entity.

The marking schema 164 defines a group of markings. In some embodiments, each one of the markings in the group of markings is a color. Thus, the encoding can result in the color-coding of the health reward parameter according to the value (e.g., magnitude and sign) of the health reward parameter. A color palette used to select a group of colors that embody the group of markings can be configurable, and can be a part of the marking schema. In other embodiments, a group of markings can be embodied in multiple shades of grey, where a particular shade of gray can represent one of the multiple health ratings. The spectrum of color or shades of grey represents a gradation of entity health conditions. The group of markings is not limited to colors or shades of grey. Indeed, in an embodiment, the marking schema can define multiple types of hatchings or stippling. In a hatching schema, density or an arrangement of lines can encode the health reward parameter. In a stippling schema, density of dots can encode the health reward parameter. The marking schema 164 can be retained in one or more memory devices 160 (referred to as repository 160). The marking schema 164 can be defined, and used, during a training stage of each classification model of the classification model(s) 144.

With respect to the training stage, each classification model 144 can be trained to implement a same multi-class classification task, and can be embodied in one or various types of machine-learning model, such as a deep neural network (DNN) multiclass classifier. After the classification model(s) 144 has been trained, application of the classification model(s) 144 to input data 104 can yield at least a quintet of classification attributes: (a marking (such as a color), health rating, health reward, signal strength, and a label).

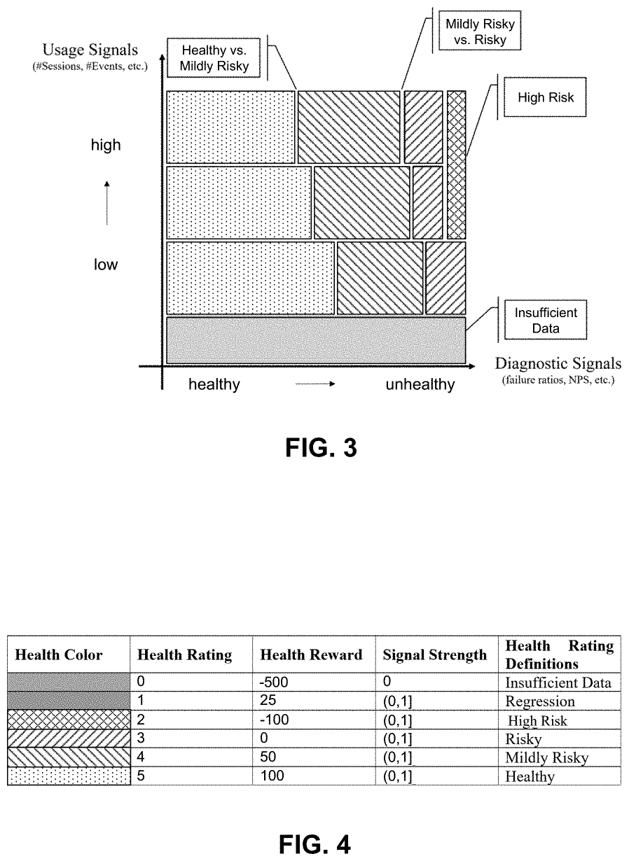

FIG. 3 illustrates an example of how marking-coding results can be mapped onto a two-dimensional feature space, in accordance with one or more embodiments of this disclosure. The marking encoding includes four hatching formats and a shade of gray, simply for purposes of illustration. In the two-dimensional feature space, horizontal axis represents the diagnostic signals, such as failure ratios for reliability, boot launch time for performance, Net Promotor Score (NPS) for customer voice feedback, and the like. The vertical axis represents usage signals, measuring a degree of confidence regarding signal accuracy. The usage domain is first discretized into different tiers. In the illustrative example, the lowest tier is rejected for further analysis because the lowest tier is not statistically sufficient and supportive to assess if an entity is healthy or not. For the rest of the slices from lower to higher usage, the distributions of diagnostic signals are analyzed separately, detecting anomalies for alert in each of the subdomain, and to learn the thresholds for cutoff between health categories; e.g., threshold between healthy and mildly risky, and threshold between mildly risky to risky. Bootstrapping and applying statistical analysis, including extreme quantiles, median absolute deviation MAD rule, interquartile range (IQR) rule, etc., can be appropriate techniques because they can measure confidence intervals to quantify model variance. Lower usage can tend to have more conservative confidence intervals, as more evidence (higher levels of unhealthiness) is needed from diagnostic signals to confidently conclude that the signal corresponds to an unhealthy state.

Because the encoding that results from application of the classification model 144 can be the same across the assessor subsystems 140, to provide markings that carry a same meaning across microservices, the assessor subsystem can rely on a mapping module 150 to encode health reward parameters. In some cases, the assessor subsystem can send a request message to encode the health reward parameter to the mapping module 150. In response, the mapping module 150 can ascribe the particular marking to the health reward parameter based on the marking schema 164. The mapping module 150 can then send a response message having formatting information indicative of the particular marking to the assessor subsystem.

FIG. 4 summarizes an example of correlation among output signals obtained by quantifying entity health. As mentioned, each marking (e.g., a color or hatching) can represent a level of product attrition. Health rating and/or health reward parameter also can represent the level of product attrition for the entity. A signal strength parameter—another one of the classification attributes that can be generated by an assessor subsystem of the assessor subsystems 140—can indicate a degree of confidence on the mapping between entity health and a marking. It is noted that for a health rating of zero (e.g., “Insufficient Data” or noise), the signal strength is zero and, thus, the health reward ascribed to such a health rating can be an arbitrary number. The number −500 is shown in FIG. 4 simply for the sake of illustration.

With further reference to FIG. 1, each one of the assessor subsystems 140 can provide health data 128 that includes one or more of formatting information identifying a particular marking, a health rating, health reward parameter, or a signal strength parameter.

Health data 128 from individual assessor subsystems 140 can be aggregated to generate an overall health score across several domains of a product. A signal strength corresponding to the overall health score also can be generated using such health data 128. The overall health score can be generated using amplified weights to determine a weighted average of health reward parameters for respective domains of a product.

More specifically, Eq. (1) and Eq. (2) can be used to combine health data 128 from individual ones of the assessor subsystems 140 to generate an overall health score and a corresponding signal strength.

Health Score=Σᵢ(Rewardᵢ×Strengthᵢ×wᵢ)/Σᵢ(Strengthᵢ×wᵢ) (1)

Signal Strength=Σᵢ(Strengthᵢ×wᵢ)/Σᵢwᵢ (2)

Where the subscript i is an index that identifies a microservice. Signal strength is given by a customized function, e.g., a step function to represent tier-based usage signal, a sigmoid function to represent continuously increasing confidence with higher usage signals, etc. Each microservice has weight wᵢ that can be amplified by multiplication with the signal strength parameters generated by the assessor subsystem identified by the index i.

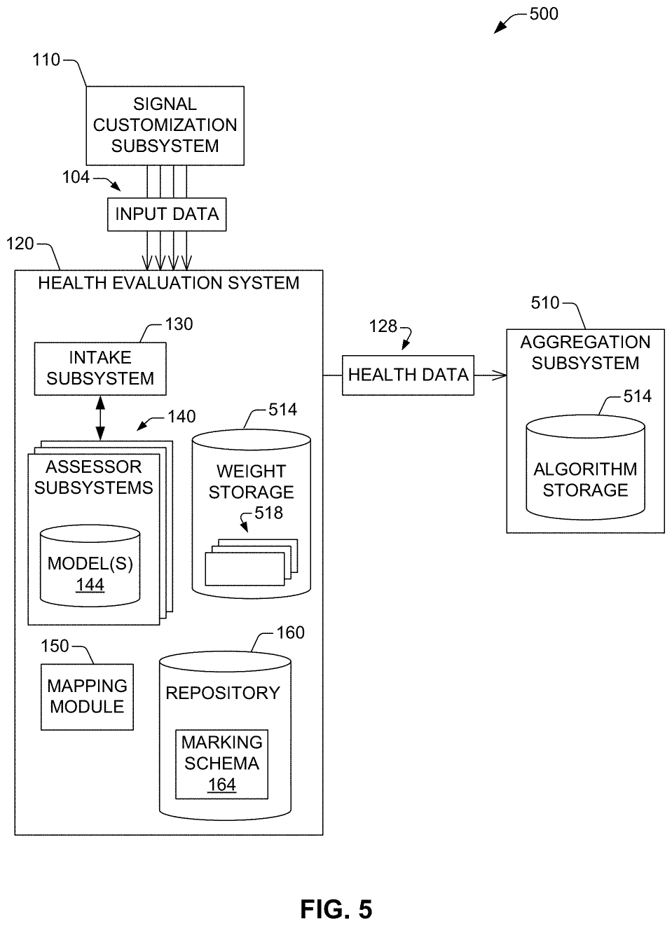

FIG. 5 illustrates an example operating environment that can generate the overall health score and corresponding signal strength, in accordance with one or more aspects of this disclosure. In an example operating environment 500, an aggregation subsystem 510 can receive health data 128 from multiple assessor subsystems 140. The health data 128 can include multiple health reward parameters, each corresponding to a particular product domain, e.g., Platform A/App. A/Reliability. The aggregation subsystem 510 can generate an overall health score using Eq. (1) and also can generate an overall signal strength using Eq. (2). To that end, the aggregation subsystem 510 can retain multiple weights 518 in weight storage 514. Each one of the weights 518 can correspond to a respective one of the assessor subsystems 140.

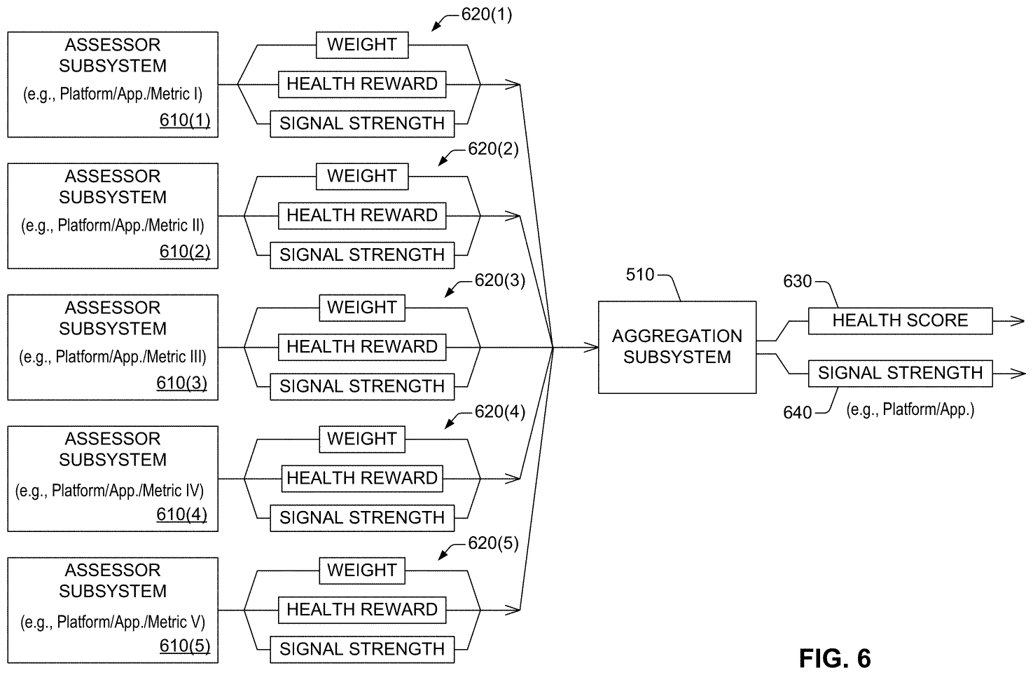

As an illustration, FIG. 6 presents an example of aggregation of health data over several domains of a product for a defined entity, in accordance with one or more aspects of this disclosure. As is illustrated in FIG. 6, the domains of a product correspond to a particular platform (“Platform”), a particular software application (“App.”), and particular metrics (“Metric I” to “Metric V,” for example). In one example, the platform can be Win32 and the software application can be Microsoft Word®. In addition, Metric I to Metric V can be embodied in usage, currency, reliability, performance, and NPS, respectively.

The aggregation subsystem 510 can receive health data from multiple assessor subsystems, including assessor subsystem 610(1), assessor subsystem 610(2), assessor subsystem 610(3), assessor subsystem 610(4), and assessor subsystem 610(5). The health data includes, health data 620(1), health data 620(2), health data 620(3), health data 620(4), and health data 620(5). The data health 620(J), with J=1, 2, 3, 4, 5, includes a weight, a health reward parameter, and a signal strength corresponding to the health reward parameters. The aggregation subsystem 510 can then determine an overall health score 630 according to Eq. (1), using the health reward parameters and weights carried by the received health data. The aggregation subsystem 510 also can determine a signal strength 640 corresponding to the overall health score 630 according to Eq. (2), using the signal strength parameters and weights carried by the received health data. As a result, entity health in the product domain Platform/App. for a particular entity is determined.

Simply as an illustration, an example computation that can be performed by the aggregation subsystem 510 is shown in the following Eq. (3) and Eq. (4):

$$Health Score = \frac{\begin{matrix}100 \times 1. \times 0.25 + 50 \times 1.0 \times 1. + 0 \times 1. \times 1. + \\ ( - 100 ) \times 0.75 \times 1.0 + 50 \times 0.0 \times 1.\end{matrix}}{1. \times 0.25 + 1.0 \times 1.0 + 1.0 \times 1. + 0.75 \times 1. + 0.0 \times 1.0} = 0 \qquad ( 3 )$$

$$Signal Strength = \frac{1.0 \times 0.25 + 1.0 \times 1 \text{.0} + 1. \times 1. + 0.75 \times 1.0 + 0.0 \times 1.0}{0.25 + 1. + 1. + 1. + 1.0} \approx 0.7 0 \qquad ( 4 )$$

Accordingly, the overall health score for Platform/App. (e.g., Win32/Word) can be equal to 0.

The type of aggregation illustrated in FIG. 6 and discussed above can be applied across multiple software applications that constitute a product, e.g., Application A, Application B, Application C, Application D, and Application E, as is illustrated in FIG. 2. The aggregation subsystem 510 can generate health scores and corresponding signal strengths from health data generated by the appropriate assessor subsystems 140.

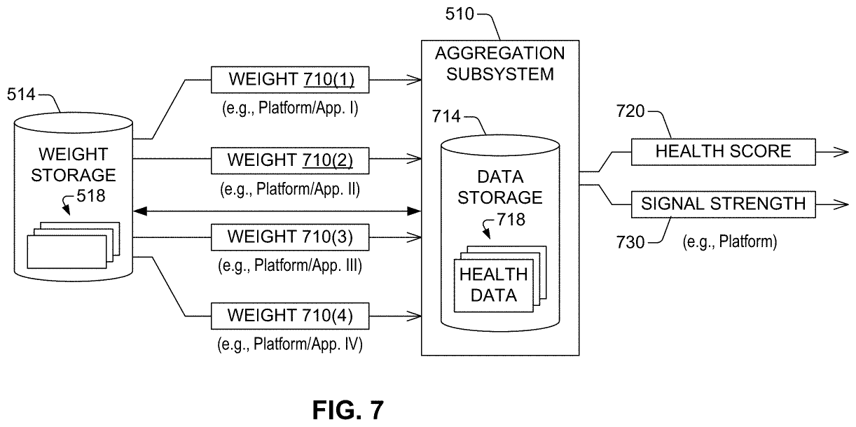

As is illustrated in FIG. 7, the aggregation subsystem 510 can retain generated health scores and signal strengths in data storage 714, as part of health data 718. Accordingly, health data (e.g., health scores and signal strengths) resulting from prior aggregations corresponding to the multiple software applications can be available to the aggregation subsystem 510. As such, to generate overall health score and corresponding signal strength for a particular platform (e.g., Win32) across those software applications, the aggregation subsystem 510 can access weight data from a weight storage 514 retained within the health evaluation system 120. The weight data can identify multiple weights for respective ones of the multiple software applications. A weight for a software application can be, for example, a usage weight represented by a number of active users during a defined period of time, who conducted at least one session in that software application. The defined period of time can be one month, for example. As is illustrated in FIG. 7, the weight data can identify a weight 710(1) corresponding to Application I, a weight 710(2) corresponding to Application II, a weight 710(3) corresponding to Application III, and a weight 710(4) corresponding to Application IV. In one example, Application I can be embodied in Word®, Application II can be embodied in Excel®, Application III can be embodied in PowerPoint®, and Application IV can be embodied in Outlook®. This disclosure is, of course, not limited to those example software applications.

The aggregation subsystem 510 can determine a health score 720 and a corresponding signal strength 730 by using Eq. (1) and Eq. (2), respectively, with the health data recorded in health data 718 and the weights received from the weight storage 514. Simply as an illustration, an example computation that can be performed by the aggregation subsystem 510 is shown in the following Eq. (5) and Eq. (6):

$$Health Score = \frac{\begin{matrix}0 \times 0. 70 \times 100 K + 80 \times 0.30 \times 20 K + \\ 55 \times 0. 25 \times 4 K + 30 \times 0.85 \times 100 K\end{matrix}}{0.7 \times 100 K + 0.3 \times 20 K + 0.3 \times 20 K + 0.85 \times 100 K} \approx 20 \qquad ( 5 )$$

$$Signal Strength = \frac{0.7 \times 100 K + 0.3 \times 20 K + 0.3 \times 20 K + 0.85 \times 100 K}{100 K + 20 K + 20 K + 100 K} \approx 0.72 \qquad ( 6 )$$

Accordingly, the overall health score for Platform (e.g., Win32) across a defined set of multiple software applications can be about 20.

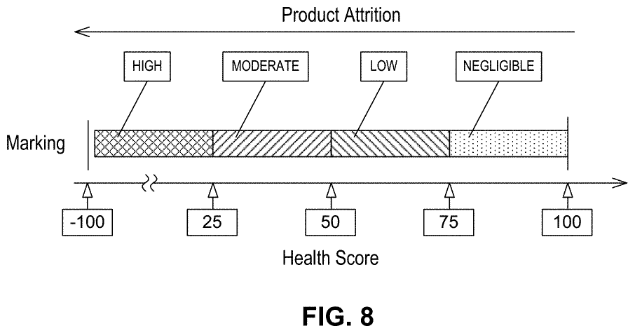

FIG. 8 illustrates an example of a mapping of health scores into a group of defined markings, in accordance with one or more embodiments of this disclosure. The defined markings can identify a particular category of product attrition. As is illustrated in FIG. 8, the group of markings has four markings, including hatching and stippling. The score-marking correlation can discretize the health score into four categories of product attrition, for example: “High,” “Moderate,” “Low,” and “Negligible”. An entity in the Negligible category can be deemed to have an acceptable to excellent product experience and, thus, can be referred to as a healthy entity.

A health score in the Moderate category or the High category can prompt corrective actions to improve product experience. An example of a corrective action can include generating and/or sending a message to a computing device (such as a user device) administered by a computing system of the entity. The additive and multiplicative scoring approach that yields the health score can permit straightforward root cause decomposition to diagnose which metrics, software application, and product, for example, contribute to product attrition. As a result of root cause decomposition, actions can be taken to transition an entity from a production attrition category to another category where the product attrition is lesser. By having an entity consuming a product in category without product attrition, a computing platform that provides the product can more efficiently utilize computing resources, such as compute time and network bandwidth.

Availability of a marking that encodes an entity health condition, either by encoding health reward parameter or an aggregated health score, can permit a computing system to cause presentation of a particular marking representing a health condition or a signal strength parameter corresponding to the particular marking. The computing system can include, or can be functionally coupled to the health evaluation system 120 or a combination of the health evaluation system 120 and the aggregation subsystem 510.

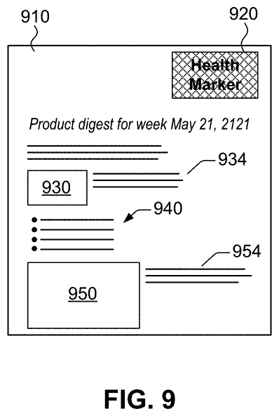

As an example, as is illustrated in FIG. 9, a particular marking 920 can be presented at a user interface 910. Simply as an illustration, the particular marking 920 shown in FIG. 9 corresponds to High category of product attrition. The user interface 910 also can include, in some embodiments, a marking 930 that embodies, or includes, a dialed diagram showing percentage of devices keeping updated in a latest application version, wherein the percentage can range from 0% to 100%. A suggested percentage point or industry average percentage point also can be shown by the marking 930, to permit an agent (e.g., an information technology (IT) administrator) of an entity to identify the entity healthiness of device configuration in a computing system of the entity. Additionally, indicia 934 conveying an explanation of the data included in the marking 930 can be presented in some cases. In addition, or in other embodiments, the user interface 910 can include a listing 940 of high product-attrition domains of product usage for the entity, such domains including Platform/Application/Metrics. Further, or in yet other embodiments, the user interface 910 can include a marking 950, such as a chart or another type of plot conveying a historical trend of marking-encoded health scores for a past period of time (e.g., the past six months or the past two weeks). Such a marking 950 can permit keeping track of product-attribution record, for example. As is shown in FIG. 9, the user interface 910 also can include indicia 954 conveying an explanation and/or insights pertaining to at least some of the data included in the marking 950. Such data is not shown in FIG. 9 for the sake of simplicity.

Regardless of the specific information besides the particular marking 920, the user interface 910 can be integrated into a web portal, a communication message (such as an email or a text message), or similar. In some cases, the particular marking 920 and/or the signal strength parameter, and/or other information can be presented in an electronic document.

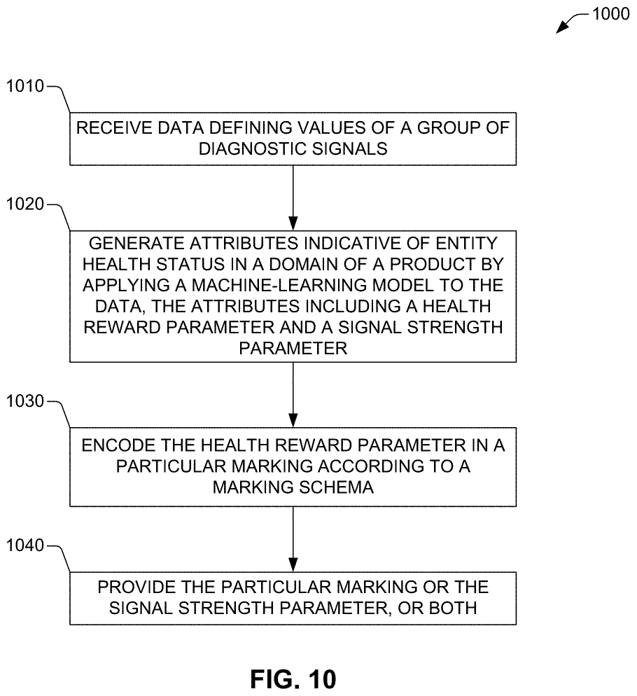

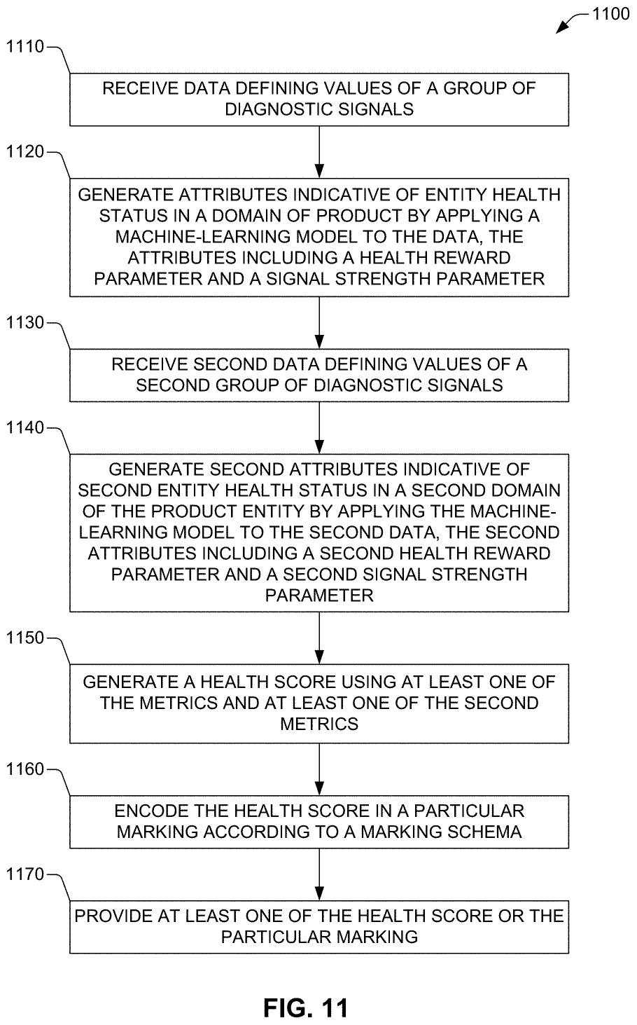

FIG. 10 illustrates an example of a method for evaluating entity health pertaining to a product, in accordance with one or more embodiments of this disclosure. A computing system can implement, entirely or partially, an example method 1000. The computing system includes, or is functionally coupled to, one or more processors, one or more memory devices, other types of computing resources, a combination thereof, or similar. Such processor(s), memory device(s), computing resource(s), individually or in a particular combination, permit or otherwise facilitate implementing the example method 1000. The computing resources can include O/Ss; software for configuration and/or control of a virtualized environment; firmware; CPU(s); GPU(s); virtual memory; disk space; downstream bandwidth and/or upstream bandwidth; interface(s) (I/O interface devices, programming interface(s) (such as APIs, etc.); controller devices(s); power supplies; a combination of the foregoing; or similar. In some cases, the computing system the implements that example method 1000 also can implement an example method 1100, as described with respect to FIG. 11.

At block 1010, the computing system can receive data defining value of a group of diagnostic signals. In some embodiments, the data can be received from a subsystem that is remotely located relative to the computing system and functionally coupled thereto.

At block 1020, the computing system can generate attributes indicative of entity health status in a domain of the product by applying a machine-learning model to the data. The attributes can include a health reward parameter and a signal strength parameter. In some embodiments, generating the metrics can include generating a classification attribute that designates the entity as having a particular health rating of a group of health ratings.

At block 1030, the computing system can encode the health reward parameter in a particular marking according to a marking schema, where the marking schema defines a group of markings, as is described herein. Data defining the marking schema can be retained in a data storage within the computing system.

At block 1040, the computing system can provide at least one of the particular marking or the signal strength parameter. In some cases, the providing of the at least one of the particular marking or the signal strength parameter includes causing presentation of at least one of the particular marking or the signal strength parameter. In some cases, one or both of the particular marking of the signal strength parameter can be presented in a user interface or an electronic document. The user interface (e.g., user interface 910) can be integrated into a web portal or a communication message.

FIG. 11 illustrates an example of a method for generating a health score that summarizes entity health pertaining to a product across domains of the product, in accordance with one or more embodiments of this disclosure. The computing system that implements the example method 1000 described with respect to FIG. 10 also can implement, entirely or partially, an example method 1100. At block 1110, the computing system can receive data defining values of a group of diagnostic signals. At block 1120, the computing system can generate attributes indicative of entity health status in a domain of the product by applying a machine-learning model to the data. The attributes can include a health reward parameter and a signal strength parameter. In some embodiments, generating the metrics can include generating a classification attribute that designates the entity as having a particular health rating of a group of health ratings. At block 1130, the computing system can receive second data defining values of a second group of diagnostic signals.

At block 1140, the computing system can generate second attributes indicative of second entity health status in a second domain of the product by applying a machine-learning model to the second data. The second attributes can include a second health reward parameter and a second signal strength parameter. As mentioned, in some embodiments, generating the second metrics can include generating a classification attribute that designates the entity as having a particular health rating of a group of health ratings.

At block 1150, the computing system can generate a health score using at least one of the metrics and at least one of the second metrics. The health score represents an aggregation of those metrics across the first and second domains of the product. As such, the health score represents health status in a higher tier of product domains. In some embodiments, generating the health score can include determining a first factor by multiplying the health reward parameter and the signal strength parameter weighted by a weight that includes the signal strength parameter. In addition, generating the health score also can include determining a second factor by multiplying the second health reward parameter and the second signal strength parameter weighted by a second weight that includes the second signal strength parameter. Further, generating the health score also includes adding the first factor and the second factor.

At block 1160, the computing system can encode the health score in a particular marking (e.g., a color or a hatching type) according to a marking schema. The marking schema can be the same as the marking schema that can be used to encode the health reward parameter and the second reward parameter individually.

At block 1170, the computing system can provide at least one of the particular marking or the health score. In some cases, the providing of the at least one of the particular marking or the health score can include causing presentation of at least one of the particular marking or the health score. In some cases, one or both of the particular marking of the health score can be presented in a user interface or an electronic document. As mentioned, the user interface (e.g., user interface 910) can be integrated into a web portal or a communication message.

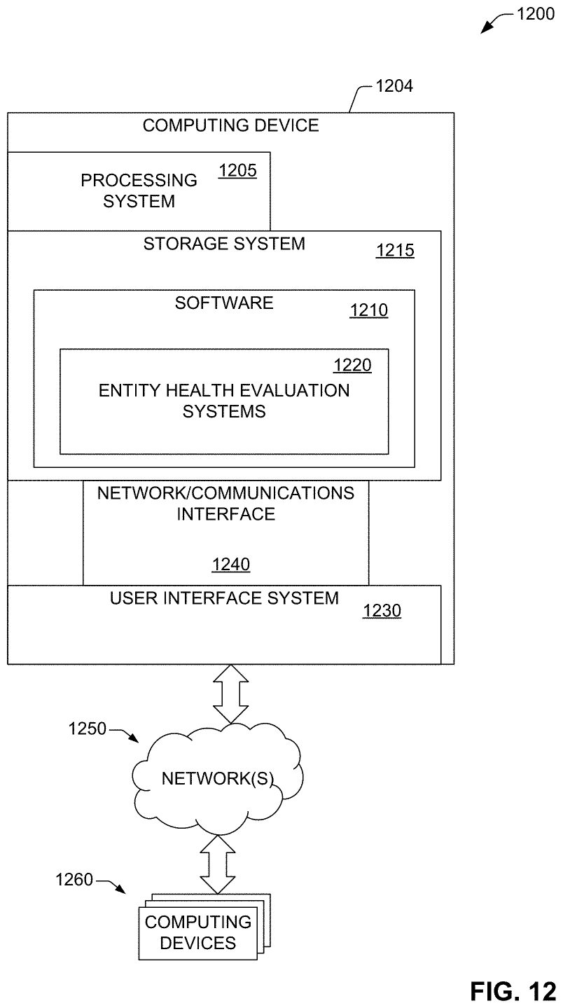

FIG. 12 illustrates an example computing environment that may carry out the described processes, in accordance with one or more embodiments of this disclosure. A computing environment 1200 may represent a computing system that includes a computing device 1204, such as a personal computer, a reader, a mobile device, a personal digital assistant, a wearable computer, a smart phone, a tablet, a laptop computer (notebook or netbook, for example), a gaming device or console, an entertainment device, a hybrid computer, a desktop computer, a smart television, or an electronic whiteboard or large form-factor touchscreen. Accordingly, more or fewer elements described with respect to the computing device 1204 can be incorporated to implement a particular computing device. The computing system also can include one or many computing devices 1260 remotely located relative to the computing device 1204. A communication architecture including one or more networks 1250 can functionally couple the computing device 1204 and the remote computing device(s) 1260.

The computing device 1204 includes a processing system 1205 having one or more processors (not depicted) to transform or manipulate data according to the instructions of software 1210 stored on a storage system 1215. Examples of processors of the processing system 1205 include general purpose central processing units (CPUs), graphics processing units (GPUs), field programmable gate arrays (FPGAs), application specific processors, and logic devices, as well as any other type of processing device, combinations, or variations thereof. The processing system 1205 can be embodied in, or included in, a system-on-chip (SoC) along with one or more other components such as network connectivity components, sensors, video display components.

The software 1210 can include an operating system and application programs. The software 1210 also can include functionality instructions. The functionality instructions can include computer-accessible instructions that, in response to execution (by at least one of the processor(s) included in the processing system 1205), can implement one or more of the automated revision summary generation described in this disclosure. The computer-accessible instructions can be both computer-readable and computer-executable, and can embody or can include one or more software components illustrated as entity health evaluation systems.

In one scenario, execution of at least one software component of the revision summary generator modules 1220 can implement one or more of the methods disclosed herein, such as the example methods 1000 and 1100. For instance, such execution can cause a processor (e.g., one of the processor(s) included in the processing system 1205) that executes the at least one software component to carry out a disclosed example method or another technique of this disclosure.

Device operating systems generally control and coordinate the functions of the various components in the computing device 1204, providing an easier way for applications to connect with lower-level interfaces like the networking interface. Non-limiting examples of operating systems include WINDOWS from Microsoft Corp., APPLE iOS from Apple, Inc., ANDROID OS from Google, Inc., and the Ubuntu variety of the Linux OS from Canonical.

It is noted that the O/S can be implemented both natively on the computing device 1204 and on software virtualization layers running atop the native device O/S. Virtualized O/S layers, while not depicted in FIG. 12, can be thought of as additional, nested groupings within the operating system space, each containing an O/S, application programs, and APIs.

Storage system 1215 can include any computer readable storage media readable by the processing system 1205 and capable of storing the software 1210 including the revision summary generator modules 1220.

Storage system 1215 may include volatile and nonvolatile memories, removable and non-removable media implemented in any method or technology for storage of information, such as computer readable instructions, data structures, program modules, or other data. Examples of storage media of storage system 1215 include random access memory, read only memory, magnetic disks, optical disks, CDs, DVDs, flash memory, magnetic cassettes, magnetic tape, magnetic disk storage or other magnetic storage devices, or any other suitable storage media. In no case does storage media consist of transitory, propagating signals.

Storage system 1215 may be implemented as a single storage device but may also be implemented across multiple storage devices or sub-systems co-located or distributed relative to each other. Storage system 1215 may include additional elements, such as a controller, capable of communicating with processing system 1205.

The computing device 1204 also can include user interface system 1230, which may include I/O devices and components that enable communication between a user and the computing device 1204. User interface system 1230 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 1230 may also include output devices such as display screen(s), speakers, haptic devices for tactile feedback, and other types of output devices. In certain cases, the input and output devices may be combined in a single device, such as a touchscreen display which both depicts images and receives touch gesture input from the user.

A natural user interface (NUI) may be included as part of the user interface system 1230 for a user to input feature selections. Examples of NUI methods include those relying on speech recognition, touch and stylus recognition, gesture recognition both on screen and adjacent to the screen, air gestures, head and eye tracking, voice and speech, vision, touch, hover, gestures, and machine intelligence. Accordingly, the systems described herein may include touch sensitive displays, voice and speech recognition, intention and goal understanding, motion gesture detection using depth cameras (such as stereoscopic or time-of-flight camera systems, infrared camera systems, red-green-blue (RGB) camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

Visual output may be depicted on the display (not shown) in myriad ways, presenting graphical user interface elements, text, images, video, notifications, virtual buttons, virtual keyboards, or any other type of information capable of being depicted in visual form.

The user interface system 1230 also can include user interface software and associated software (e.g., for graphics chips and input devices) executed by the O/S in support of the various user input and output devices. The associated software assists the O/S in communicating user interface hardware events to application programs using defined mechanisms. The user interface system 1230 including user interface software may support a graphical user interface, a natural user interface, or any other type of user interface.

Network interface 1240 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Alternatively, or in addition, the functionality, methods, and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods, and processes included within the hardware modules.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A system, comprising:
at least one processor;
at least one memory device having instructions encoded thereon that, in response to execution by the at least one processor, cause the system to:
receive data defining values of a group of diagnostic signals pertaining to a domain of a product of an entity;
generate attributes indicative of entity health condition in the domain by applying a machine-learning model to the data, the attributes comprising a health reward parameter and a signal strength parameter; and
encode the health reward parameter in a particular marking according to a marking schema.

2. The system of claim 1, wherein generating the attributes comprises generating a classification attribute that designates the entity as having a particular health rating of a group of health ratings.

3. The system of claim 1, the at least one memory device having further instructions encoded thereon that, in response to execution by the at least one processor, further cause the system to cause presentation of at least one of the particular marking or the signal strength parameter.

4. The system of claim 1, wherein the marking schema defines a group of markings including multiple colors, a first color of the multiple colors corresponding to a first range of health reward parameters and a second color of the multiple colors corresponding to a second range of health reward parameters.

5. The system of claim 1, the at least one memory device having further instructions encoded thereon that, in response to execution by the at least one processor, further cause the system to,
receive second data defining values of a second group of diagnostic signals pertaining to a second domain of the product;
generate second attributes indicative of second entity health condition in the second domain by applying a second machine-learning model to the second data, the second attributes comprising a second health reward parameter and a second signal strength parameter.

6. The system of claim 5, the at least one memory device having further instructions encoded thereon that, in response to execution by the at least one processor, further cause the system to encode the second health reward parameter in a second particular marking according to the marking schema.

7. The system of claim 5, the at least one memory device having further instructions encoded thereon that, in response to execution by the at least one processor, further cause the system to generate a health score using the health reward parameter, the signal strength parameter, the second health reward parameter, and the second signal strength parameter.

8. The system of claim 7, the at least one memory device having further instructions encoded thereon that, in response to execution by the at least one processor, further cause the system to encode the health score to a second particular marking according to the marking schema.

9. The system of claim 7, wherein generating the health score comprises,
determining a first factor by multiplying the health reward parameter and the signal strength parameter weighted by a weight that includes the signal strength parameter;
determining a second factor by multiplying the second health reward parameter and the second signal strength parameter weighted by a second weight that includes the second signal strength parameter; and
adding the first factor and the second factor.

10. The system of claim 1, wherein the product comprises a business-to-business software-as-a-service product.

11. A computer-implemented method, comprising:
receiving, by a computing system comprising at least one processor, data defining values of a group of diagnostic signals pertaining to a domain of a product of an entity;
generating, by the computing system, attributes indicative of entity health condition in the domain by applying a machine-learning model to the data, the attributes comprising a health reward parameter and a signal strength parameter; and
encoding, by the computing system, the health reward parameter in a particular marking according to a marking schema.

12. The computer-implemented method of claim 11, wherein the generating comprises generating a classification attribute that designates the entity as having a particular health rating of a group of health ratings.

13. The computer-implemented method of claim 11, further comprising causing, by the computing system, presentation of at least one of the particular marking or the signal strength parameter.

14. The computer-implemented method of claim 11, further comprising,
receiving, by the computing system, second data defining values of a second group of diagnostic signals pertaining to a second domain of a product;
generating, by the computing system, second attributes indicative of second entity health condition of the entity in the second domain by applying a second machine-learning model to the second data, the second attributes comprising a second health reward parameter and a second signal strength parameter.

15. The computer-implemented method of claim 14, further comprising generating, by the computing system, a health score using the health reward parameter, the signal strength parameter, the second health reward parameter, and the second signal strength parameter.

16. The computer-implemented method of claim 15, further comprising encoding, by the computing system, the health score to a second particular marking according to the marking schema.

17. At least one computer-readable storage medium having instructions encoded thereon that, in response to execution, cause a computing system to perform or facilitate operations comprising:
receiving data defining values of a group of diagnostic signals pertaining to a domain of a product of an entity;
generating attributes indicative of entity health condition in the domain by applying a machine-learning model to the data, the attributes comprising a health reward parameter and a signal strength parameter; and
encoding the health reward parameter in a particular marking according to a marking schema.

18. The at least one computer-readable storage medium of claim 17, wherein the generating comprises generating a classification attribute that designates the entity as having a particular health rating of a group of health ratings.

19. The at least one computer-readable storage medium of claim 17, the operations further comprising causing presentation of at least one of the particular marking or the signal strength parameter.

20. The at least one computer-readable storage medium of claim 17, the operations further comprising,
receiving second data defining values of a second group of diagnostic signals pertaining to a second domain of a product;
generating second attributes indicative of second entity health condition of the entity in the second domain by applying a second machine-learning model to the second data, the second attributes comprising a second health reward parameter and a second signal strength parameter; and
generating a health score using the health reward parameter, the signal strength parameter, the second health reward parameter, and the second signal strength parameter.
